(19) United States
(12) Patent Application Publication
(10) Pub. No.: US 2009/0231288 A1
(43) Pub. Date: Sep. 17, 2009

(54) HAND-HELD ELECTRONIC DEVICE AND COMBINED INPUT METHOD THEREOF

(75) Inventor: Chien-Chung LIAO, Taipei City (TW)

Correspondence Address: Chih Feng Yeh;BRIAN M. MCINNIS, 12th Floor, Ruttonjee House, 11 Duddell Street, Hong Kong, HK

(73) Assignee: INVENTEC CORPORATION

(21) Appl. No.: 12/049,797

(22) Filed: Mar. 17, 2008

(51) Int. Cl. G06F 3/041

(52) U.S. Cl. 345/173

(57) ABSTRACT

A hand-held electronic device comprising a first touch panel module, a second touch panel module and a central processing unit is provided. The first touch panel module generates a first touch signal when touched, transforms the first touch signal into a first digital voltage and outputs the first digital voltage. The second touch panel module generates a second touch signal when touched, transforms the second touch signal into a second digital voltage and outputs the second digital voltage. The central processing unit coupled with the first touch panel module and the second touch panel module receives the first digital voltage and the second digital voltage, performs a function calculation based on the first digital voltage and the second digital voltage to perform a first function, a second function or a third function selectively. Moreover, a combined input method for the hand-held electronic device is also disclosed in specification.

### BACKGROUND

1. Field of Invention

The present invention relates to an electronic device and an input method thereof. More particularly, the present invention relates to a hand-held electronic device and a combined input method thereof.

2. Description of Related Art

With the fast development of hand-held electronic devices, such as laptops, PDA, digital cameras, digital displays, mobile phones etc, the hand-held electronic devices usually have a touch panel. The touch panel is the apparatus attached to a screen of the hand-held electronic device. The user can lightly touch the option displayed on the screen, such that the hand-held electronic device may transmit data or show a message.

In the principle of induction, the touch panel may be a capacitive touch panel, a resistive touch panel, an infrared touch panel or an acoustic wave touch panel. In the field of the hand-held electronic devices, the resistive touch panel is widely used for handwriting and the capacitive touch panel has become more popular.

However, users may ergonomically operate the resistive touch panel using the stylus. Nevertheless, touch sensing of the resistive touch panel is commonplace for single point of contact. On the other hand, multi-touch sensing enables the user to interact with the capacitive touch panel with more than one finger at a time. Nevertheless, it is not desirable that the capacitive touch panel is used for handwriting because the area of induction is too large.

For the foregoing reasons, there is a need for a new hand-held electronic device and a combined input method thereof, such that the user may conveniently and quickly operate the new hand-held electronic device by executing the combined input method.

### SUMMARY

It is therefore an objective of the present invention to provide a hand-held electronic device.

In accordance with an embodiment of the present invention, the hand-held electronic device comprises a first touch panel module, a second touch panel module and a central processing unit. The first touch panel module generates a first touch signal when touched, transforms the first touch signal into a first digital voltage and outputs the first digital voltage. The second touch panel module generates a second touch signal when touched, transforms the second touch signal into a second digital voltage and outputs the second digital voltage. The central processing unit coupled with the first touch panel module and the second touch panel module receives the first digital voltage and the second digital voltage, performs a function calculation based on the first digital voltage and the second digital voltage to perform a first function, a second function or a third function selectively. Moreover, a combined input method for the hand-held electronic device is also disclosed in specification.

It is another objective of the present invention to provide a combined input method for the hand-held electronic device.

In accordance with another embodiment of the present invention, a combined input method comprises the following steps. A first touch signal is generated when touched, the first touch signal is transformed into a first digital voltage, and the first digital voltage is outputted. A second touch signal is generated when touched, the second touch signal is transformed into a second digital voltage, and the second digital voltage is outputted. Then, the first digital voltage and the second digital voltage are received. Last, a function calculation is performed based on the first digital voltage and the second digital voltage, and a first function, a second function or a third function is selectively performed.

It is to be understood that both the foregoing general description and the following detailed description are by examples, and are intended to provide further explanation of the invention as claimed.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a block diagram of a hand-held electronic device according to an embodiment of the present invention;

FIG. 2 is a flow chat of a combined input method according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

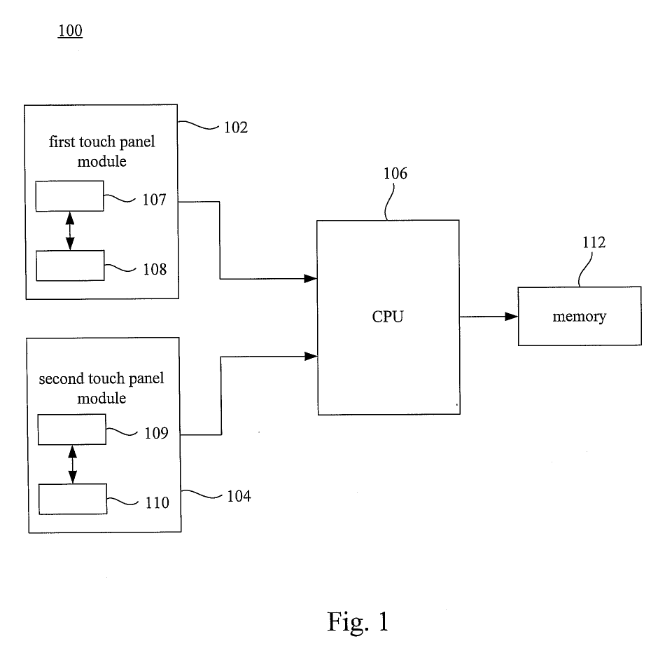

Please refer to FIG. 1. FIG. 1 is a block diagram of a hand-held electronic device according to an embodiment of the present invention. The hand-held electronic device 100 may comprise a first touch panel module 102, a second touch panel module 104, a central processing unit (CPU) 106 and a memory 112. The central processing unit 106 is coupled with the first touch panel module 102, the second touch panel module 104 and the memory 112. If the user wants to operate the hand-held electronic device 100, he or she may touch the first touch panel module 102. When touched the first touch panel module 102 generates a first touch signal, transforms the first touch signal into a first digital voltage and outputs the first digital voltage. Alternatively, or additionally, if the user wants to operate the hand-held electronic device 100, he or she may touch the second touch panel module 104. When touched the second touch panel module 104 generates a second touch signal when touched, transforms the second touch signal into a second digital voltage and outputs the second digital voltage. Then, the central processing unit 106 receives the first digital voltage and the second digital voltage, performs a function calculation based on the first digital voltage and the second digital voltage, where the function calculation may transform the first digital voltage and the second digital voltage into a first position data and a second position data, respectively. Then, the central processing unit 106 may perform a corresponding function selected from the group consisting of a first function, a second function and a third function according to the function calculation. For example, the central processing unit 106 may perform the first function according to the first position data. Alternatively, the central processing unit 106 may perform the second function according to the second position data. Alternatively, the central processing unit 106 may perform the third function according to the first set of second position data and the second position data, where the third function corresponds to a combination of the first and second position data stored in the memory 112. Thus, the user may touch the first touch panel module 102 and/or the second touch panel module 104 and then the central processing unit 106 may perform the first function, the second function or the third function, which achieves an objective to operate the hand-held electronic device 100.

In FIG. 1, the first touch panel module 102 may comprise a first touch area 107 and a first analog-to-digital converter 108. The first touch area 107 is electrically coupled with the first analog-to-digital converter 108. The first touch area 107 generates the first touch signal when touched and outputs the first touch signal to the first analog-to-digital converter 108. Then, the first analog-to-digital converter 108 receives the first touch signal, transforms the first touch signal into a first digital voltage, and outputs the first digital voltage to the central processing unit 106. Additionally, the second touch panel module 104 may comprise a second touch area 109 and a second analog-to-digital converter 110. The second touch area 109 is electrically coupled with the second analog-to-digital converter 110. The second touch area 109 generates the second touch signal when touched and outputs the second touch signal to the second analog-to-digital converter 110. Then, The second analog-to-digital converter 110 receives the second touch signal, transforms the second touch signal into a second digital voltage, and outputs the second digital voltage to the central processing unit 106.

In an embodiment, if the user touches the first touch panel module 102, the first touch panel module 102 outputs the first digital voltage. Then, the central processing unit 106 receives the first digital voltage and transforms the first digital voltage into the first position data. After the first position data is received, the central processing unit 106 performs the function calculation that may determine whether the second position data is received during a first predetermined period. Then, the central processing unit 106 performs the first function according to the first position data when the second position data is not received during the first predetermined period. For example, the first predetermined period is 2 seconds. After the user touches the first touch panel module 102, however, she or he doesn't touch the second touch panel module 104 during the 2 seconds. For this reason, the central processing unit 106 performs the first function. On the other hand, the central processing unit 106 performs the function calculation that may determine whether the first position data is received between a period of receiving two sequential second position data when the first position data is received during the first predetermined period. For example, if the user changes the points of contact that he or she touched on the second touch area 109 of the second touch panel module 104, the second set of second position data may be generated. Alternatively, if the user's finger or the stylus leaves the second touch area 109 of the second touch panel module 104, the central processing unit 106 performs the function calculation anew. On the other hand, the central processing unit 106 performs the second function according to the second position data when the first position data is not received between the period of receiving two sequential second position data. In contrast, the central processing unit 106 searches for the third function corresponding with the first and second position data when the first position data is received between the period of receiving two sequential second position data, where the third function is stored in the memory, and performs the third function. Thus, the user can selectively touch the first touch panel module 102 and/or the second touch panel module 104, such that the hand-held electronic device 100 performs the corresponding function. It is convenient for the user to quickly operate the hand-held electronic device 100.

It should be noted that the first touch panel module 102 may be a capacitive touch panel module, a resistive touch panel module, an infrared touch panel module or an acoustic wave touch panel module. Alternatively, or additionally, the second touch panel module 104 may be also a capacitive touch panel module, a resistive touch panel module, an infrared touch panel module or an acoustic wave touch panel module. It will be readily understood by those skilled in the art that touch panel modules may be varied while remaining within the scope of the present invention.

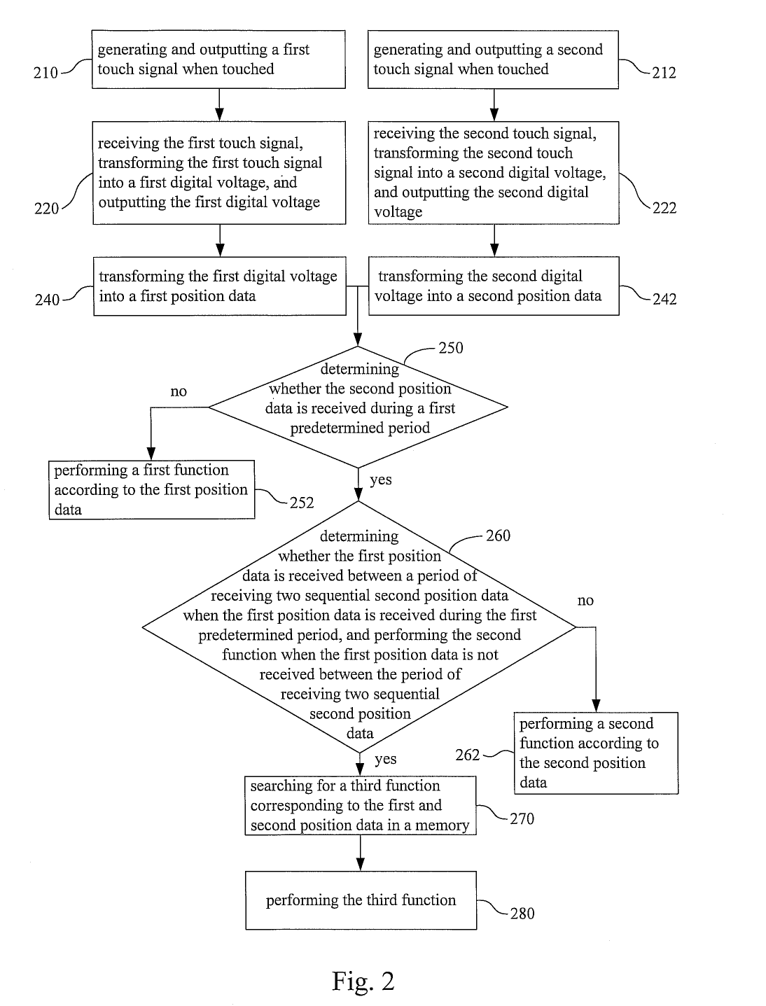

For a more complete understanding of the present invention, and the advantages thereof, please refer to FIG. 2. FIG. 2 is a flow chat of a combined input method for the hand-held electronic device 100 according to an embodiment of the present invention. In FIG. 2, if the user touches the first touch panel module 102, the first touch area 107 generates the first touch signal when touched and outputs the first touch signal to the first analog-to-digital converter 108 in step 210. Then, the first analog-to-digital converter 108 receives the first touch signal, transforms the first touch signal into a first digital voltage, and outputs the first digital voltage to the central processing unit 106 in step 220. Then, the central processing unit 106 receives the first digital voltage and transforms the first digital voltage into the first position data in step 240. Alternatively, or additionally, if the user touches the second touch panel module 104, the second touch area 109 generates the second touch signal when touched and outputs the second touch signal to the second analog-to-digital converter 110 in step 212. Then, the second analog-to-digital converter 110 receives the second touch signal, transforms the second touch signal into a second digital voltage, and outputs the second digital voltage to the central processing unit 106 in step 222. Then, the central processing unit 106 receives the second digital voltage and transforms the second digital voltage into the second position data in step 242.

In an embodiment, the central processing unit 106 may perform the function calculation based on the first digital voltage and the second digital voltage and then the central processing unit 106 may selectively perform the first function, the second function or the third function according to the function calculation. First, after the first position data is received, the function calculation is capable of determining whether the second position data is received during the first predetermined period in step 250. Then, the central processing unit 106 performs the first function when the second position data is not received during the first predetermined period in step 252. Alternatively, in step 260, the function calculation is capable of determining whether the first position data is received between a period of receiving two sequential second position data when the first position data is received during the first predetermined period. For example, if the user changes the points of contact that she or he touched on the second touch area 109 of the second touch panel module 104, the second set of second position data may be generated, alternatively, if the finger or the stylus of the user leaves the second touch area 109 of the second touch panel module 104, the function calculation is performed anew. Then, in step 262, the central processing unit 106 performs the second function according to the second position data when the first position data is not received between the period of receiving two sequential second position data. In contrast, in step 270, the central processing unit 106 searches for the third function corresponding with the first and second position data when the first position data is received between the period of receiving two sequential second position data, where the third function is stored in a memory. Finally, the central processing unit 106 performs the third function in step 280. Thus, it is convenient for the user to quickly operate the hand-held electronic device 100 by executing the combined input method.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hand-held electronic device, comprising:
a first touch panel module for generating a first touch signal when touched, transforming the first touch signal into a first digital voltage and outputting the first digital voltage;
a second touch panel module for generating a second touch signal when touched, transforming the second touch signal into a second digital voltage and outputting the second digital voltage; and
a central processing unit coupled with the first touch panel module and the second touch panel module for receiving the first digital voltage and the second digital voltage, performing a function calculation based on the first digital voltage and the second digital voltage to perform a first function, a second function or a third function selectively.

2. The hand-held electronic device as claimed in claim 1, wherein the function calculation comprising:
transforming the first digital voltage and the second digital voltage into a first position data and a second position data.

3. The hand-held electronic device as claimed in claim 2, wherein the function calculation further comprising:
determining whether the second position data is received during a first predetermined period when the central processing unit receives the first position data, and wherein the central processing unit performs the first function when the second position data is not received during the first predetermined period.

4. The hand-held electronic device as claimed in claim 3, wherein the function calculation further comprising
determining whether the first position data is received between a period of receiving two sequential second position data when the first position data is received during the first predetermined period, and the central processing unit performs the second function when the first position data is not received between the period of receiving two sequential second position data.

5. The hand-held electronic device as claimed in claim 4, wherein the function calculation further comprising:
the central processing unit searches for the third function stored in a memory corresponding with the first and second position data when the first position data is received between the period of receiving two sequential second position data, then the central processing unit performs the third function.

6. The hand-held electronic device as claimed in claim 1, wherein the first touch panel module comprising:
a first touch area for generating and outputting the first touch signal when touched; and
a first analog-to-digital converter electrically coupled with the first touch area for receiving the first touch signal, transforming the first touch signal into a first digital voltage, and outputting the first digital voltage.

7. The hand-held electronic device as claimed in claim 1, wherein the second touch panel module comprising:
a second touch area for generating and outputting the second touch signal when touched; and
a second analog-to-digital converter electrically coupled with the second touch area for receiving the second touch signal, transforming the second touch signal into a second digital voltage, and outputting the second digital voltage.

8. The hand-held electronic device as claimed in claim 1, wherein the first touch panel module is a capacitive touch panel module, a resistive touch panel module, an infrared touch panel module or an acoustic wave touch panel module.

9. The hand-held electronic device as claimed in claim 1, wherein the second touch panel module is a capacitive touch panel module, a resistive touch panel module, an infrared touch panel module or an acoustic wave touch panel module.

10. A combined input method for a hand-held electronic device, the combined input method comprising:
generating a first touch signal when touched, transforming the first touch signal into a first digital voltage and outputting the first digital voltage;
generating a second touch signal when touched, transforming the second touch signal into a second digital voltage and outputting the second digital voltage;
receiving the first digital voltage and the second digital voltage; and
performing a function calculation based on the first digital voltage and the second digital voltage, and performing a first function, a second function or a third function selectively.

11. The combined input method as claimed in claim 10, wherein the function calculation comprising
transforming the first digital voltage and the second digital voltage into a first position data and a second position data.

12. The combined input method as claimed in claim 11, wherein the function calculation further comprising
determining whether the second position data is received during a first predetermined period when the first position data is received, and performing the first function when the second position data is not received during the first predetermined period.

13. The combined input method as claimed in claim 12, wherein the function calculation further comprising
determining whether the first position data is received between a period of receiving two sequential second position data when the first position data is received during the first predetermined period, and performing the second function when the first position data is not received between the period of receiving two sequential second position data.

14. The combined input method as claimed in claim 13, wherein the function calculation further comprising
searching for the third function stored in a memory corresponding with the first and second position data when the first position data is received between the period of receiving two sequential second position data, then performing the third function.

15. The combined input method as claimed in claim 10, wherein the step of generating the first touch signal when touched, transforming the first touch signal into the first digital voltage and outputting the first digital voltage:
generating and outputting the first touch signal when touched; and
receiving the first touch signal, transforming the first touch signal into the first digital voltage, and outputting the first digital voltage.

16. The combined input method as claimed in claim 10, wherein the step of generating the second touch signal when touched, transforming the second touch signal into the second digital voltage and outputting the second digital voltage:
generating and outputting the second touch signal when touched; and
receiving the second touch signal, transforming the second touch signal into the second digital voltage, and outputting the second digital voltage.
